(19) United States
(12) Patent Application Publication
(10) Pub. No.: US 2004/0052595 A1
(43) Pub. Date: Mar. 18, 2004

(54) Drill bit point storage system

(76) Inventors: Tyler J. Dembicks, Raleigh, NC (US); Andrew E. Dembicks, Raleigh, NC (US)

Correspondence Address: Mark D. Passler, Akerman Senterfitt, P.O. Box 3188, West Palm Beach, FL, 33402-3188, US

(21) Appl. No.: 10/246,881

(22) Filed: Sep. 18, 2002

(51) Int. Cl. B23B 51/00

(52) U.S. Cl. 408/226

(57) ABSTRACT

A drill bit point storage system comprising a drill bit and at least one cavity in at least a portion of the drill bit for storing at least one drill bit point. The system can also include a coupling device for securing the drill bit point when the drill bit point is stored within the cavity of the drill bit. In one arrangement, the coupling device can be a cover positioned substantially around the drill bit in which at least a first portion of the cover can have a shape that can substantially correspond to a shape of said portion of the drill bit such that the first portion of the cover can be substantially adjacent to the portion of the drill bit. The first portion of the cover can be at least partially positioned over the cavity when the drill bit point is stored therein.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND

1. Technical Field

The present invention relates generally to power tools, and more particularly to electrical or battery powered drills.

2. Description of Related Art

Electric drills, whether powered from an electrical power grid or rechargeable batteries, can be used to bore holes or indentations into a wide variety of materials. Most conventional drills include a chuck for detachably engaging any number of drill bits. Drill bits are manufactured in many different sizes and are constructed of various materials. As an example, many manufacturers produce drill bits ranging in diameter anywhere from one-eighth of an inch to one-half of an inch. Additionally, drills used for boring holes in concrete or other masonry are typically constructed of cobalt to withstand the rigors of such a process.

In view of the vast selection of choices among drill bits, some manufacturers have sought to increase the versatility of drill bits by incorporating detachable drill bit points into the tip of a drill bit. As a result, any number of drill bit points can be coupled to a single drill bit. Switching drill bit points has two primary advantages: (1) the life of a particular drill bit can be greatly extended, as most wear of these devices occurs at the point of the bit; and (2) a single drill bit can be used to drill a number of varying materials. As an example of the latter, a user can employ a drill bit point to bore holes into a soft wood such as pine and can switch to a drill bit point that is designed for use with a hard wood like oak.

Unfortunately, because of their small size, it is quite easy to lose or misplace drill bit points. As such, many drill bit points are stored as part of a set of drill bit points or are stashed in a toolbox or some other suitable container. Even so, when a user wishes to replace a drill bit point, it can be inconvenient to access such storage units. Thus, a need exists for a system that can provide quick and easy access to drill bit points and reduce the possibility that such points will be lost without increasing the complexity or cost of a drilling system.

### BRIEF DESCRIPTION OF THE DRAWINGS

FIG. 1 is a perspective view of a drill bit point storage system in accordance with the inventive arrangements.

FIG. 2 is a partial side view of a drill bit point and a drill bit in accordance with the inventive arrangements.

FIG. 3 is a partial perspective view of a drill bit point storage system in accordance with the inventive arrangements.

FIG. 4 is a perspective view of a coupling device in accordance with the inventive arrangements.

FIG. 5 is a partial side view of the coupling device of FIG. 4 engaged with a drill bit in accordance with the inventive arrangements.

FIG. 6 illustrates another example of a coupling device in accordance with the inventive arrangements.

### SUMMARY OF THE INVENTION

The present invention concerns a drill bit point storage system. The system includes a drill bit and at least one cavity in at least a portion of the drill bit for storing at least one drill bit point. In one arrangement, the system can further include a coupling device for securing the drill bit point when the drill bit point is stored within the cavity of the drill bit. The coupling device can be a cover positioned substantially around the drill bit in which at least a first portion of the cover can have a shape that can substantially correspond to a shape of the portion of the drill bit such that the first portion of the cover can be substantially adjacent to the portion of the drill bit. The first portion of the cover can be least partially positioned over the cavity when the drill bit point is stored therein.

In another arrangement, at least a second portion of the cover can have a shape that can substantially correspond to the shape of the portion of the drill bit, and the second portion can include an opening. This opening of the second portion of the cover can be positioned over the cavity to provide access to the drill bit point when the drill bit point is stored in the cavity. In addition, the first portion of the cover can be selectively slidably engaged to the drill bit such that the first portion of the cover can slidably engage the drill bit when a moving force is applied to the cover and can frictionally engage the drill bit when the moving force is removed. This moving force can be a substantially rotational moving force.

In one aspect of the system, the coupling device can be a fastener substantially nestled within the cavity for detachably engaging the drill bit point when the drill bit point is stored within the cavity. The fastener can be a snap. In another aspect, the portion of the drill bit can contain a predetermined number of sides, and each of at least a portion of the sides can contain at least one of the cavities. Each cavity can also have one of a plurality of predetermined lengths.

In another embodiment of the invention, the drill bit point can be detachably engageable to the drill bit. The drill bit point can include an elongated member and the drill bit can include a slot for receiving the elongated member. Additionally, the system can further include a fastener for securing the drill bit point to the drill bit when the slot of the drill bit receives the elongated member of the drill bit point. In one arrangement, the fastener can be a set screw.

The present invention also concerns a method for switching a drill bit point. The method includes the steps of providing a drill bit having at least one cavity in at least a portion of the drill bit, storing at least a first drill bit point in one of the cavities, removing a second drill bit point from the drill bit, removing the first drill bit point from the cavity and detachably engaging the first drill bit point to the drill bit. The method can also include the steps of storing the second drill bit point in one of the cavities of the drill bit and providing a coupling device for securing the first and second drill bit points in at least one of the cavities.

### DETAILED DESCRIPTION OF THE PREFERRED EMBODIMENTS

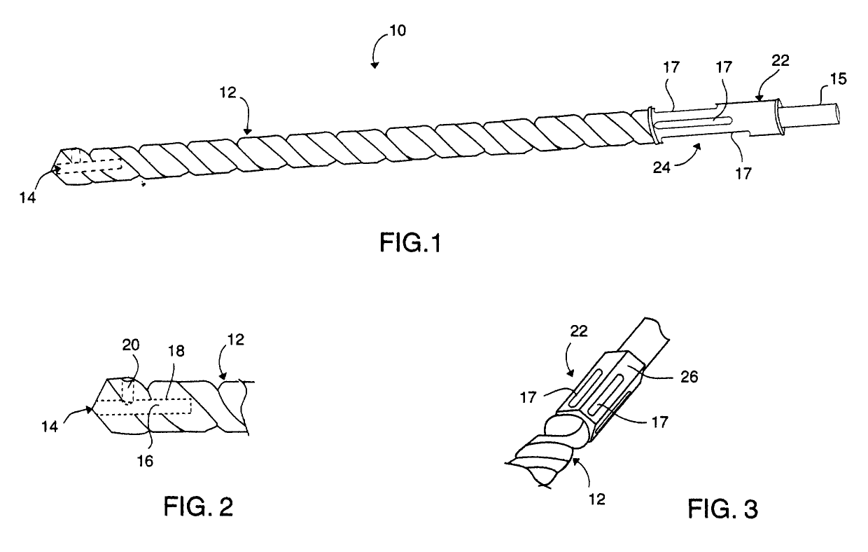

Referring to FIG. 1, a drill bit point storage system 10 in accordance with the inventive arrangements is shown. The system 10 can include a drill bit 12 having a drill bit point 14. In one arrangement, the drill bit point 14 can be detachably engageable to the drill bit 12. A detachably engageable drill bit point 14 permits a user to switch to any other suitable drill bit point. In addition, the drill bit 12 can be any suitable device used for boring holes or indentations into a suitable material and is not limited to the configuration as shown in FIG. 1. The drill bit 12 can also include a chuck extension 15. A chuck of a drill (not shown) can be used to detachably engage the chuck extension 15 when the drill bit 12 is to be used with the drill.

As shown in FIG. 2, the drill bit point 14 can include an elongated member 16, and the drill bit 12 can have a slot 18 for receiving the elongated member 16. The system 10 can further include a fastener 20 for securing the drill bit point 14 to the drill bit 12 when the slot 18 of the drill bit 12 receives the elongated member 16 of the drill bit point 14. As an example, the fastener 20 can be a set screw. Those of ordinary skill in the art, however, will appreciate that any other suitable device can be used to secure the drill bit point 14 to the drill bit 12 when the slot 18 receives the elongated member 16.

Referring back to FIG. 1, the drill bit can include one or more cavities 17 in at least a portion 22 of the drill bit 12, which can be used to store one or more drill bit points 14. As such, should a user wish to attach a drill bit point 14 to the drill bit 12 or to switch drill bit points 14, the user can merely access the cavity 17 that is storing the desired drill bit point 14. In one arrangement, the cavities 17 can be located at an end 24 of the drill bit 12. The end 24 can be positioned away from the drill bit point 14 and adjacent to the chuck extension 15. Such a configuration can prevent the cavities 17 from interfering with any drilling operations or the engagement of a drill's chuck with the chuck extension 15.

In another arrangement, the shape of the portion 22 of the drill bit 12 that contains the cavities 17 can have a shape that substantially corresponds or conforms to the overall shape of the drill bit 12. As an example, if the shape of the drill bit 12 is substantially circular, as depicted in FIG. 1, the shape of the portion 22 of the drill bit 12 can also be substantially circular. For purposes of the invention, the term “substantially circular” can mean true circular as well as slight or even moderate deviations therefrom.

The invention, however, is not limited in this regard, as the portion 22 of the drill bit 12 can have any other suitable configuration. For example, referring to FIG. 3, the portion 22 can have a predetermined number of sides 26, a design in accordance with such geometric patterns as a hexagon or an octagon. In this arrangement, any number of the predetermined sides 26 can contain one or more cavities 17.

Referring to FIGS. 1 and 3, in one arrangement, each of the cavities 17 can have a predetermined length. Each predetermined length can be any predetermined distance suitable for storing one or more drill bit points 14 of any size. Employing a wide variety of predetermined lengths can permit the system 10 to store drill bit points 14 of numerous sizes. Nevertheless, the cavities 17 are not limited to any particular shape or any particular dimensions. As such, the invention is not limited to the cavities 17 shown in FIGS. 1 and 3, as those cavities 17 are merely suitable examples in accordance with the inventive arrangements.

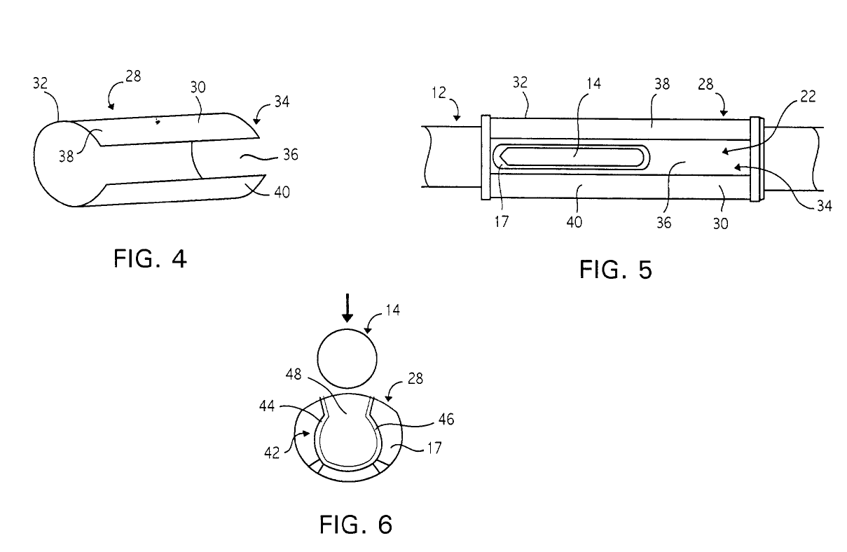

Referring to FIGS. 4 and 5, the system 10 can also include a coupling device 28 for securing a drill bit point 14 when the drill bit point 14 is stored within a cavity 17 of the drill bit 12. In one arrangement, the coupling device 28 can be a cover 30 that can be substantially positioned around the drill bit 12. The cover 30 can include a first portion 32 that can have a shape that substantially corresponds to a shape of the portion 22 of the drill bit 12. For purposes of the invention, the term “substantially corresponds” can mean an exact correspondence or slight or even moderate deviations therefrom.

Additionally, the first portion 32 of the cover 30 can be at least partially positioned over one or more cavities 17 when the cavities 17 are storing drill bit points 14. As an example and as shown in FIGS. 4 and 5, the portion 22 of the drill bit 12 can be substantially circular, and the first portion 32 of the cover 30 can be substantially circular as well. This configuration can permit the first portion 32 of the cover 30 to secure a drill bit point 14 in its respective cavity 17.

The cover 30 also can have a second portion 34 that can have a shape that substantially corresponds to the shape of the portion 22 of the drill bit 12. The second portion 34 can also have a first end 38 and a second end 40 and an opening 36 between the first end 38 and the second end 40. The opening 36 can provide access to stored drill bit points 14 in any one of the cavities 17. It is understood, however, that the second portion 34 is not limited to this particular arrangement, as the second portion 34 can have any other suitable configuration for providing access to the cavities 17.

In another arrangement and without limitation, the first portion 32 of the cover 30 can be selectively slidably engaged to the drill bit 12. When a moving force is applied to the cover 30, the first portion 32 of the cover 30 can slidably engage the drill bit 12, and when the moving force is removed, the first portion 32 can frictionally engage the drill bit 12. This moving force can be a substantially rotational moving force, which can cause the cover 30 to rotate in a circular or substantially circular fashion. Based on this rotation and the selective engagement by the first portion 32, a user can easily and quickly access one or more drill bit points 14 as they are stored in a cavity 17 or return the drill bit points 14 to the appropriate cavity 17 for storage.

Referring to FIG. 6, another example of a suitable coupling device 28 in accordance with the inventive arrangements is illustrated. In this example, the coupling device 28 can be a fastener 42, which can be substantially nestled within one or more cavities 17 and can detachably engage one or more drill bit points 14 when the drill bit points 14 are stored in the cavities 17. The term “substantially nestled” can refer to fasteners 42 in which no portion of the fastener 42 is exposed outside a cavity 17 and can also refer to fasteners 42 having portions that extend slightly or even moderately outside a cavity 17.

In one arrangement and as depicted in FIG. 6, the fastener 42 can be a snap. In this arrangement, the fastener 42 can have a first side 44 and a second side 46 opposable to the first side 44. A gap 48 can exist between the first side 44 and the second side 46, which can have a width that is less than the width or diameter of a drill bit point 14. The first side 44 and the second side 46 can be constructed of a material that enables the first side 44 and second side 46 to expand as a drill bit point 14 is forced through the gap 48 and to return to their original configuration after the drill bit point 14 moves through the gap 48.

Those of ordinary skill in the art will appreciate that the invention is not limited to this particular fastener 42, as any other suitable fastener can be used. In fact, it is understood that the invention is not limited to either of the coupling devices 28 described above, as any other suitable device for securing the drill bit points 14 in the cavities 17 can be used.

While preferred embodiments of the invention have been illustrated and described, it will be clear the invention is not so limited. Numerous modifications, changes, substitutions and equivalents will occur to those skilled in the art without departing from the spirit and scope of the invention as described in the claims.

What is claimed is:

1. A drill bit point storage system, comprising:
a drill bit; and
at least one cavity in at least a portion of said drill bit for storing at least one drill bit point.

2. The system according to claim 1, further comprising a coupling device for securing said drill bit point when said drill bit point is stored within said cavity of said drill bit.

3. The system according to claim 2, wherein said coupling device is a cover positioned substantially around said drill bit.

4. The system according to claim 3, wherein at least a first portion of said cover has a shape that substantially corresponds to a shape of said portion of said drill bit.

5. The system according to claim 4, wherein said first portion of said cover is at least partially positioned over said cavity when said drill bit point is stored therein.

6. The system according to claim 5, wherein at least a second portion of said cover has a shape that substantially corresponds to said shape of said portion of said drill bit and said second portion includes an opening.

7. The system according to claim 6, wherein said opening of said second portion of said cover is positioned over said cavity to provide access to said drill bit point when said drill bit point is stored in said cavity.

8. The system according to claim 5, wherein said first portion of said cover is selectively slidably engaged to said drill bit such that said first portion of said cover slidably engages said drill bit when a moving force is applied to said cover and frictionally engages the drill bit when said moving force is removed.

9. The system according to claim 8, wherein the moving force is a substantially rotational moving force.

10. The system according to claim 2, wherein said coupling device is a fastener substantially nestled within said cavity for detachably engaging said drill bit point when said drill bit point is stored within said cavity.

11. The system according to claim 10, wherein said fastener is a snap.

12. The system according to claim 1, wherein said portion of said drill bit contains a predetermined number of sides;
wherein each of at least a portion of said sides contains at least one of said cavities.

13. The system according to claim 1, wherein each cavity has one of a plurality of predetermined lengths.

14. The system according to claim 1, wherein said drill bit point is detachably engageable to said drill bit.

15. The system according to claim 14, wherein said drill bit point includes an elongated member and said drill bit includes a slot for receiving said elongated member.

16. The system according to claim 15, further comprising a fastener for securing said drill bit point to said drill bit when said slot of said drill bit receives said elongated member of said drill bit point.

17. The system according to claim 16, wherein said fastener is a set screw.

18. A method for switching a drill bit point, comprising the steps of:
providing a drill bit having at least one cavity in at least a portion of the drill bit; and
storing at least a first drill bit point in one of the cavities.

19. The method according to claim 18, further comprising the steps of:
removing a second drill bit point from the drill bit;
removing the first drill bit point from the cavity; and
detachably engaging the first drill bit point to the drill bit.

20. The method according to claim 19, further comprising the steps of:
storing the second drill bit point in one of the cavities of the drill bit; and
providing a coupling device for securing the first and second drill bit points in at least one of the cavities.
